(19) United States
(12) Patent Application Publication
(10) Pub. No.: US 2026/0132906 A1
(43) Pub. Date: May 14, 2026

(54) OVER MOULDED LED MODULE WITH INTEGRATED HEATSINK AND OPTIC

(71) Applicants: Lumileds LLC, San Jose, CA (US); Covestro Deutschland AG, Leverkusen (DE)

(72) Inventors: Benno SPINGER, Aachen (DE); Rainier PROTTE, Leverkusen (DE); Thorsten SCHULZ, Leverkusen (DE); Christoph BONTENACKELS, Leverkusen (DE); Liang XIN, Leverkusen (DE)

(73) Assignees: Lumileds LLC, San Jose, CA (US); Covestro Deutschland, Leverkusen (DE)

(21) Appl. No.: 19/120,121

(22) PCT Filed: Oct. 10, 2023
(86) PCT No.: PCT/US2023/034800

§ 371 Date: Apr. 10, 2025

Related U.S. Application Data
(63) Continuation of application No. PCT/US2022/051610, filed on Dec. 2, 2022.
(60) Provisional application No. 63/414,815, filed on Oct. 10, 2022.
(60) Provisional application No. 63/416,254, filed on Oct. 14, 2022.

(51) Int. Cl. F21S 45/48; F21Y 115/10

(52) U.S. Cl. CPC F21S 45/48; F21Y 2115/10

(57) ABSTRACT

A method of manufacturing a light emitting diode (LED) headlight unit that includes an integrally molded heat sink, LED module, and optics component. The method of manufacturing includes injection molding the heat sink that incorporates the LED module in a first injection molding step and then forming the optics component on the top surface of the heatsink in a second injection molding step. In an alternative method of manufacturing the LED headlight unit with the integrally molded heat sink, LED module, and optics component, the optics component is molded first, and the heat sink is molded onto the bottom surface of the optics component, thereby integrating the LED module into the heat sink.

### CROSS REFERENCE TO RELATED APPLICATIONS

This application claims the benefit of International Patent Application No. PCT/US2022/051610, filed Dec. 2, 2022, U.S. Provisional Application No. 63/416,254, filed Oct. 14, 2022, and U.S. Provisional Application No. 63/414,815, filed Oct. 10, 2022, the contents of which are incorporated herein by reference.

### BACKGROUND

Contemporary automotive headlamp systems may include light emitting diode (LED) modules coupled to a headlamp optic. The headlight optic may direct light generated by the LED module onto the roadway. The orientation of the LED module relative to the headlight optic is critical as small deviations in the alignment can result in improper illumination of the roadway. In addition to the LED modules and the headlight optics, the headlight systems often have an additional heatsink attached to dissipate the heat generated by the LED modules.

In many contemporary automotive headlamps, the different parts of the headlamp systems are produced separately and then finally assembled by means of gluing, screwing, etc. This results in a final production step that has a high risk of leading to a product with non-sufficient illumination characteristics, as already small deviations play a large role.

### SUMMARY

A method of manufacturing a light emitting diode (LED) headlight unit that includes an integrally molded heat sink, LED module, and optics component. The method of manufacturing includes injection molding the heat sink that incorporates the LED module in a first injection molding step and then forming the optics component on the top surface of the heatsink in a second injection molding step In an alternative method of manufacturing the LED headlight unit with the integrally molded heat sink, LED module, and optics component, the optics component is molded first, and the heat sink is molded onto the bottom surface of the optics component, thereby integrating the LED module into the heat sink.

### BRIEF DESCRIPTION OF THE DRAWINGS

A more detailed understanding can be had from the following description, given by way of example in conjunction with the accompanying drawings wherein:

FIGS. 1A and 1B are perspective views of an LED lighting system;

FIGS. 2A and 2B are perspective views of another LED lighting system;

FIGS. 3A and 3B graphically illustrate the tolerance stack-up for the assembly of the lighting systems of FIGS. 1A, 1B, 2A and 2B;

FIG. 4 is a schematic perspective view of an example LED headlight unit incorporating over-molded LED modules;

FIG. 5A is a flow diagram of an example method of manufacturing the LED headlight unit of FIG. 4;

FIG. 5B is a flow diagram of an example an alternative method of manufacturing the LED headlight unit of FIG. 4;

FIGS. 6A and 6B illustrate an example molding apparatus that may be utilized for forming an LED headlight unit that incorporates the over-molded LED system of FIG. 4;

FIG. 7 is a diagram of an example vehicle headlamp system; and

FIG. 8 is a diagram of another example vehicle headlamp system.

### DETAILED DESCRIPTION

Examples of different light illumination systems and/or light emitting diode (“LED”) implementations will be described more fully hereinafter with reference to the accompanying drawings. These examples are not mutually exclusive, and features found in one example may be combined with features found in one or more other examples to achieve additional implementations. Accordingly, it will be understood that the examples shown in the accompanying drawings are provided for illustrative purposes only, and they are not intended to limit the disclosure in any way. Like numbers refer to like elements throughout.

It will be understood that, although the terms first, second, third, etc. may be used herein to describe various elements, these elements should not be limited by these terms. These terms may be used to distinguish one element from another. For example, a first element may be termed a second element, and a second element may be termed a first element without departing from the scope of the present invention unless expressively specified otherwise. As used herein, the term “and/or” may include any and all combinations of one or more of the associated listed items.

It will be understood that when an element such as a layer, region, or substrate is referred to as being “on” or extending “onto” another element, it may be directly on or extend directly onto the other element, or intervening elements may also be present. In contrast, when an element is referred to as being “directly on” or extending “directly onto” another element, there may be no intervening elements present. It will also be understood that when an element is referred to as being “connected” or “coupled” to another element, it may be directly connected or coupled to the other element and/or connected or coupled to the other element via one or more intervening elements. In contrast, when an element is referred to as being “directly connected” or “directly coupled” to another element, there are no intervening elements present between the element and the other element. It will be understood that these terms are intended to encompass different orientations of the element in addition to any orientation depicted in the figures.

Relative terms such as “below,” “above,” “upper,” “lower,” “horizontal,” or “vertical” may be used herein to describe a relationship of one element, layer, or region to another element, layer, or region as illustrated in the figures. It will be understood that these terms are intended to encompass different orientations of the device in addition to the orientation depicted in the figures.

Halogen lamps have been the default light source for many years for automotive head lighting. However, recent advances in LED technology with concomitant new design possibilities and energy efficiency has spurred interest in finding a legal replacement for halogen that is based on LED technology. LED technology for instance being used in a newly designed automotive headlight requires advanced heat management. Mounting LEDs on a metal heat sink is a common way to cool LEDs. In a typical LED headlamp, the main heat transport mechanism may comprise heat conduction through an LED, solder, a printed circuit board (PCB), and/or a lead frame and the heat sink. With a fan, this may enable forced convection from the heat sink surface to the air volume inside the automotive headlamp. This may differ from halogen lamps, which may exhibit heat transfer via thermal radiation so that additional components, such as a heat sink, may not be necessary. These additional components may also need significant space in the automotive headlamp and, thus, part of the lighting device may need to be located outside of an automotive headlamp (e.g., outside of the reflector housing). Embodiments described herein provide a lighting device and a method for producing such a lighting device that mimics conventional halogen lamp pendants in their outer form and has sufficient cooling.

Embodiments of the light-emitting diode (LED) headlight unit may be utilized as an LED retrofit or as a standalone lighting system in a vehicle designed to support LED lighting.

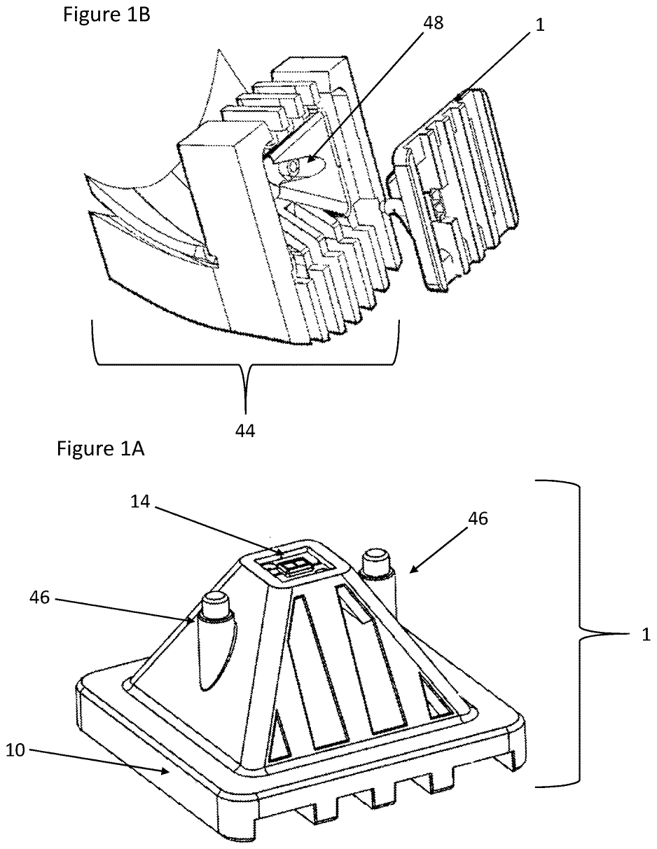

FIG. 1A and FIG. 1B are schematic perspective views of an LED lighting system. Similar LED lighting systems are described in U.S. Pat. No. 10,260,705 entitled “LED lighting module with heat sink and a method of replacing an LED module,” which is hereby incorporated by reference. In the example illustrated in FIG. 1A and FIG. 1B, the LED module 1 includes a heat sink 10 and LEDs 14. The LED module 1 may also include guide rails 46 that may align the LED module 1 relative to the optical component 44 when screws are inserted into the guide rails and fastened to the connection feature 48 of the optical component, as shown in FIG. 1B. Accordingly, in this LED system, the screws inserted in the guide rails 46 enable the relative positional adjustment of the LED module 1.

In the example LED lighting system of FIGS. 1A and 1B, the LED module 1 may move relative to the optical component 44, which may result in an improper alignment of the LED module 1 and the optical component 44. In addition, LED systems, such as illustrated in FIGS. 1A and 1B, may be formed from multiple LED modules, each of which needs to be properly aligned relative to each other and the optical component. As a result, the light generated by the LED system of FIGS. 1A and 1B may be improperly projected on the roadway. The misalignment of the LED module 1 and the optical component 44 may be caused by over-tightening or under-tightening the screws that hold the LED module 1 to the optical component 44. In addition, the existing LED system may require additional labor to screw the LED module 1 to the optical component 44.

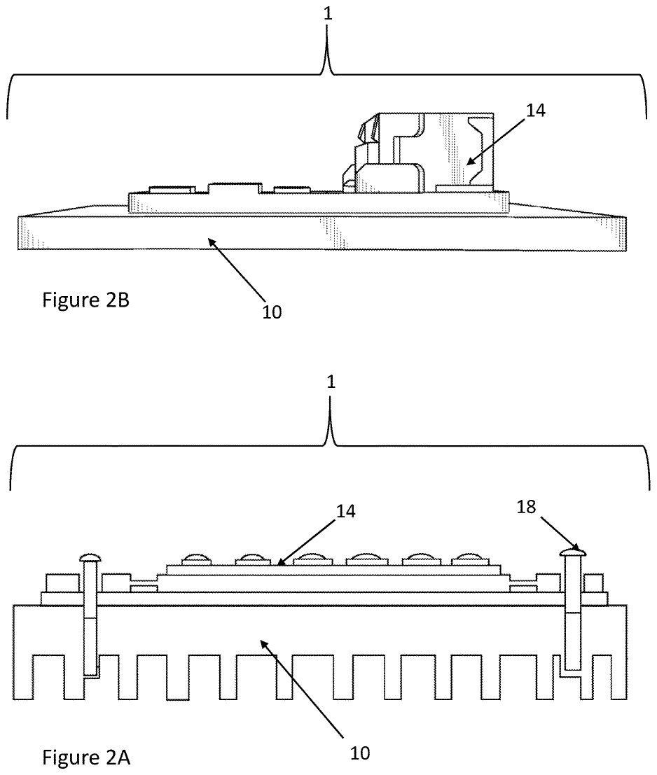

FIG. 2A illustrates an example of an LED module 1 where the LEDs 14 are connected to the heat sink 10 via screws 18. In this context, the heat sink 10 may be understood to be a passive heat exchanger that transfers the heat generated to a gaseous or fluid medium, such as environmental air, so that heat may flow or be dissipated away from the lighting module. Thermally, such a heat sink may fulfill the function of heat spreading of high local fluxes in a light source region and/or may provide a large surface to the surrounding fluid or gaseous medium (e.g., environmental air). The heat sink 10 is generally made from a thermally conductive material, for example a metallic material, such as aluminum, copper, and/or aluminum and/or copper-based alloys.

FIG. 2B is another example of an LED module 1. Similar LED modules are described in US Patent Pub. No. 20210385937 entitled “Insert-molded electronic modules using thermally conductive polycarbonate and molded interlocking features,” which is hereby incorporated by reference. In the example illustrated in FIG. 2B, the heatsink 10 is formed from a thermally conductive polycarbonate that is injection molded to interlock with the LEDs 14. In this LED module, the optical component 44 (not pictured) may be connected to the LED module 1 via screws or other fasters in a subsequent manufacturing step. Therefore, like in the system described with regard to FIGS. 1A and 1B, this LED modules suffers from the potential misalignment of the LEDs and the optical component, which results in the roadway being improperly illuminated.

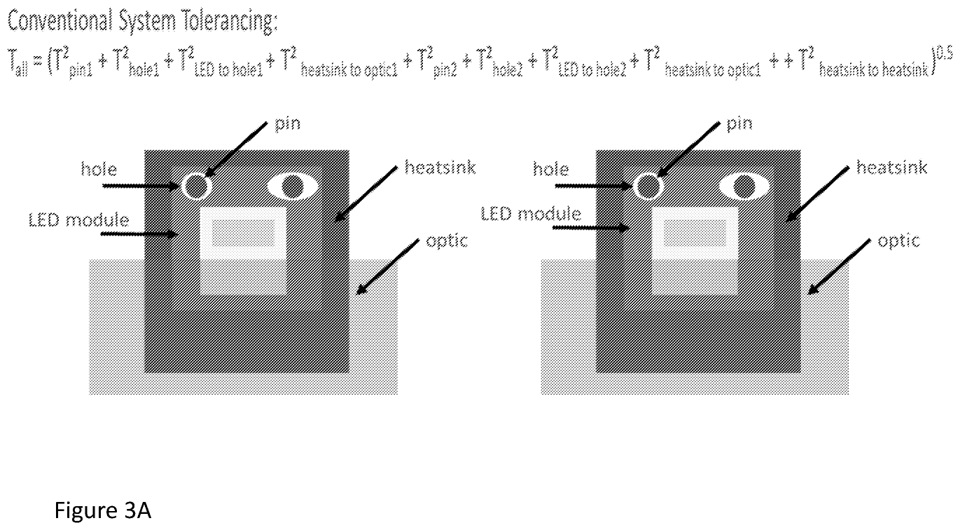

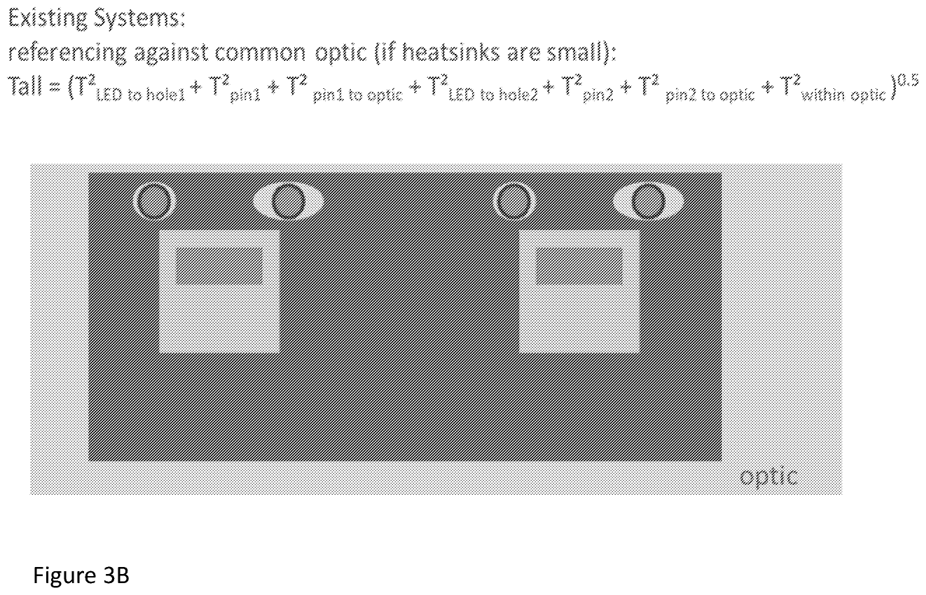

FIGS. 3A and 3B illustrate the tolerance stack-up for assembling the existing LED systems as described in FIGS. 2A and 2B. The tolerance stack-up is the process of adding tolerances together before manufacturing in order to understand their cumulative effect on part production. Specifically, FIG. 3A shows the tolerancing stack-up when the heat sink, circuit board, and optics are screwed together, as described in FIG. 2A. Similarly, FIG. 3B shows the tolerancing stack-up when the heat sink is molded to the circuit board as described in FIG. 2B. Although FIG. 2B illustrates the tolerance stack-up for a heat sink that is molded to the circuit board, a similar tolerance stack-up would occur when the heat sink is glued to the circuit board.

Accordingly, as shown in FIGS. 3A and 3B, the mechanical fastening of the LED module to the heatsink and the optics requires a large tolerance. However, the alignment of an LED headlight system in a vehicle requires very tight tolerances in order to properly illuminate the roadway.

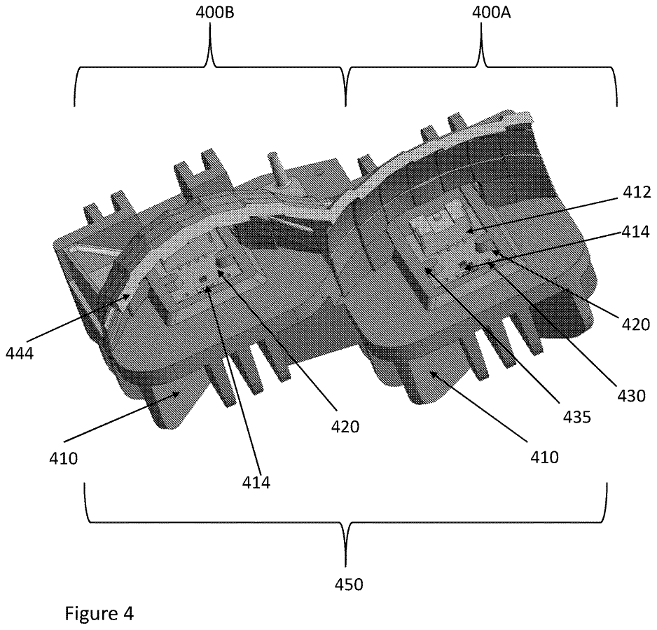

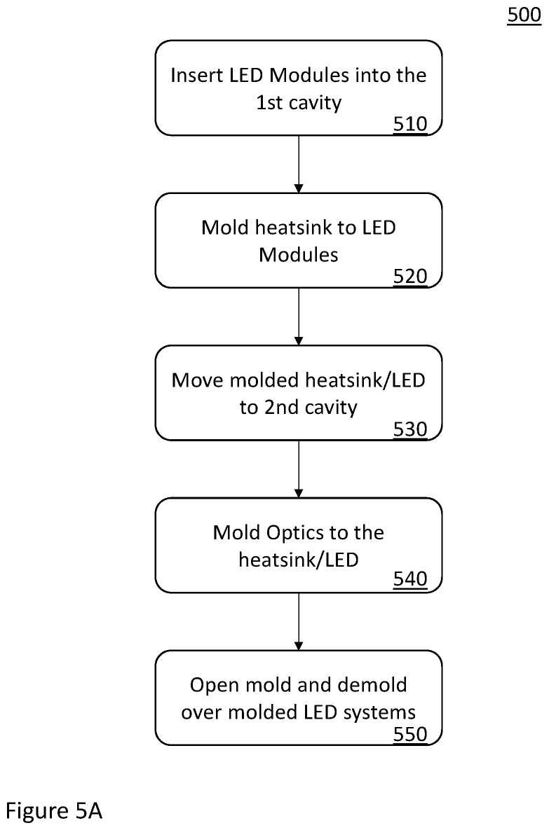

FIG. 4 illustrates an example LED headlight unit 450. In the example illustrated in FIG. 4, two over-molded LED systems 400A and 400B, are integrally formed to form a LED headlight unit 450. Although FIG. 4 illustrates an LED headlight unit 450 with two over-molded LED systems, in some instances, an LED headlight unit 450 may be formed with a single over-molded LED system. In other instances, the LED headlight unit 450 may be integrally formed from more than two over-molded LED systems.

The over-molded LED system 450 may overcome the shortcomings of conventional LED systems by molding the heat sink 410, the LED module 420, and the optics component 444 as a single integral part. A single integral part means that the heat sink 410, the led module 420, and optics component 444 are connected in the molding process without needing screws or glues. For example, molding the LED system as a single part, any misalignment of the LED module and the optics component 444 may be substantially reduced or eliminated entirely due to the elimination of the screws, fasteners and any other referencing features required by conventional systems. In addition, by molding the LED system 400 as a single part, the production and the assembly process may be improved and simplified by no longer requiring the additional steps of fastening the LED module 420 to the optics 444.

The molded LED systems 400A and 400B may each include an optics component 444 that is integrally molded with the LED module 420 and the heat sink 410. Preferably, the optics component 444 is a lens, a reflector, a mirror or a prism. More preferably, the optics component 444 is a reflector.

In yet other instances, the LED systems 400A and 400B may share a common optics component 444. In other instances, each LED system 400A and 400B may have a separate optics component.

The selection of the thermoplastic is critically important because the material needs to be dimensionally stable and compatible with the thermoplastic of the heat sink 410. In some examples, the optics component 444 is formed from a material such as filled polycarbonate (e.g., dimensional stable Makrolon® DS801) or an unfilled polycarbonate (e.g., Makrolon® 2405), or a polycarbonate blend, e.g. with polyesters such as PBT, PET or ABS.

If a filled thermoplastic, in particular a filled polycarbonate or polycarbonate blend is used for the optics component, in particular a reflector, vario-thermal temperature control is used for molding the optics component. The aromatic polycarbonate can be a mixture of one or more aromatic polycarbonates.

According to the invention, “aromatic polycarbonates” or else just “polycarbonates” is to be understood as meaning both homopolycarbonates and copolycarbonates, in particular aromatic ones. These polycarbonates may be linear or branched in known fashion. According to the invention, mixtures of polycarbonates may also be used.

A portion, preferably up to 80 mol %, more preferably of 20 mol % to 50 mol %, of the carbonate groups in the polycarbonates used in accordance with the invention may have been replaced by aromatic dicarboxylic ester groups. Polycarbonates of this type that incorporate not only acid radicals derived from carbonic acid but also acid radicals derived from aromatic dicarboxylic acids in the molecular chain are referred to as aromatic polyester carbonates. For the purposes of the present invention, they are covered by the umbrella term “thermoplastic aromatic polycarbonates”.

Replacement of the carbonate groups by the aromatic dicarboxylic ester groups proceeds essentially stoichiometrically and also quantitatively and the molar ratio of the reaction partners is therefore also reflected in the final polyester carbonate. The aromatic dicarboxylic ester groups can be incorporated either randomly or blockwise.

Aromatic polycarbonates selected in accordance with the invention preferably have weight-average molecular weights M_{w} of 15 000 to 40 000 g/mol, more preferably of 16 000 to 34 000 g/mol, even more preferably of 17 000 to 33 000 g/mol, most preferably of 19 000 to 32 000 g/mol. The values for M_{w} here are determined by a gel permeation chromatography, calibrated against bisphenol A polycarbonate standards using dichloromethane as eluent, calibration with linear polycarbonates (made of bisphenol A and phosgene) of known molar mass distribution from PSS Polymer Standards Service GmbH, Germany; calibration according to method 2301-0257502-09D (2009 Edition in German) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of column material: 3 μm to 20 μm. Concentration of solutions: 0.2% by weight. Flow rate: 1.0 ml/min, temperature of solutions: 30° C. Detection using a refractive index (RI) detector.

The polycarbonates are preferably produced by the interfacial process or the melt transesterification process, which have been described many times in the literature.

With regard to the interfacial process reference is made for example to H. Schnell, “Chemistry and Physics of Polycarbonates”, Polymer Reviews, Vol. 9, Interscience Publishers, New York 1964 p. 33 et seq., to Polymer Reviews, Vol. 10, “Condensation Polymers by Interfacial and Solution Methods”, Paul W. Morgan, Interscience Publishers, New York 1965, Chapt. VIII, p. 325, to Dres. U. Grigo, K. Kircher and P. R-Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pp. 118-145 and also to EP 0 517 044 A1.

The melt transesterification process is described, for example, in the “Encyclopedia of Polymer Science”, Vol. 10 (1969), Chemistry and Physics of Polycarbonates, Polymer Reviews, H. Schnell, Vol. 9, John Wiley and Sons, Inc. (1964), and in patent specifications DE 10 31 512 A and U.S. Pat. No. 6,228,973 B1.

Particulars pertaining to the production of polycarbonates are disclosed in many patent documents spanning approximately the last 40 years. Reference may be made here by way of example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718, and finally to U. Grigo, K. Kirchner and P. R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117-299.

The production of aromatic polycarbonates is effected for example by reaction of dihydroxyaryl compounds with carbonic halides, preferably phosgene, and/or with aromatic dicarboxyl dihalides, preferably benzenedicarboxyl dihalides, by the interfacial process, optionally using chain terminators and optionally using trifunctional or more than trifunctional branching agents, production of the polyester carbonates being achieved by replacing a portion of the carbonic acid derivatives with aromatic dicarboxylic acids or derivatives of the dicarboxylic acids, specifically with aromatic dicarboxylic ester structural units according to the carbonate structural units to be replaced in the aromatic polycarbonates. Preparation via a melt polymerization process by reaction of dihydroxyaryl compounds with, for example, diphenyl carbonate is likewise possible.

Dihydroxyaryl compounds suitable for the production of polycarbonates are for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein and the ring-alkylated, ring-arylated and ring-halogenated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (I) to (III)

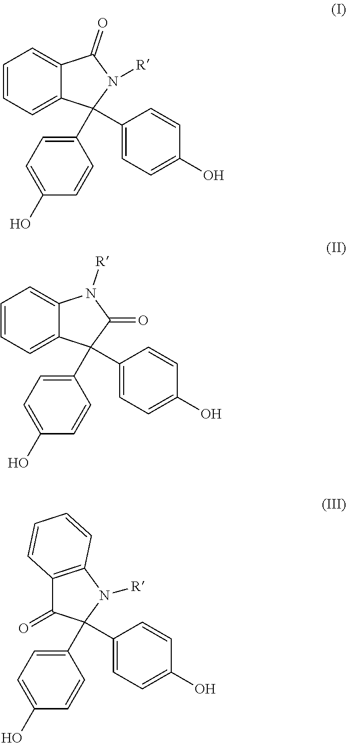

in which R′ in each case stands for C₁- to C₄-alkyl, aralkyl or aryl, preferably for methyl or phenyl, very particularly preferably for methyl.

Particularly preferred dihydroxyaryl compounds are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane, 4,4′-dihydroxybiphenyl, and dimethylbisphenol A and also the diphenols of formulae (I), (II) and (Ill).

These and other suitable dihydroxyaryl compounds are described for example in U.S. Pat. Nos. 3,028,635 A, 2,999,825 A, 3,148,172 A, 2,991,273 A, 3,271,367 A, 4,982,014 A und 2,999,846 A, in DE 1 570 703 A, DE 2063 050 A, DE 2 036 052 A, DE 2 211 956 A and U.S. Pat. No. 2,999,846 A, in DE 1 570 703 A, DE 2063 050 A, DE 2 036 052 A, DE 2 211 956 A and DE 3 832 396 A, in FR 1 561 518, in the monograph “H. Schnell, Chemistry and Physics of Polycarbonates, Interscience Publishers, New York 1964” and also in JP 62039/1986 A, JP 62040/1986 A and JP 105550/1986 A.

In the case of homopolycarbonates only one dihydroxyaryl compound is used; in the case of copolycarbonates two or more dihydroxyaryl compounds are used. The dihydroxyaryl compounds employed, similarly to all other chemicals and assistants added to the synthesis, may be contaminated with the contaminants from their own synthesis, handling and storage. However, it is desirable to use raw materials of the highest possible purity.

Suitable carbonic acid derivatives are for example phosgene and diphenyl carbonate.

Suitable chain terminators that may be used in the production of polycarbonates are monophenols. Suitable monophenols are for example phenol itself, alkylphenols such as cresols, p-tert-butylphenol, cumylphenol and mixtures thereof.

Preferred chain terminators are the phenols mono- or polysubstituted by linear or branched C₁- to C₃₀-alkyl radicals, preferably unsubstituted or substituted by tert-butyl. Particularly preferred chain terminators are phenol, cumylphenol and/or p-tert-butylphenol.

The amount of chain terminator to be employed is preferably 0.1 to 5 mol % based on the moles of diphenols employed in each case. The addition of the chain terminators may be effected before, during or after the reaction with a carbonic acid derivative.

Suitable branching agents are the trifunctional or more than trifunctional compounds familiar in polycarbonate chemistry, in particular those having three or more than three phenolic OH groups. Suitable branching agents are for example 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis(3-methyl-4-hydroxyphenyl)-2-oxo-2,3-dihydroindole. The amount of the branching agents for optional employment is preferably 0.05 mol % to 2.00 mol %, based on moles of dihydroxyaryl compounds used in each case. The branching agents may be either initially charged together with the dihydroxyaryl compounds and the chain terminators in the aqueous alkaline phase or added dissolved in an organic solvent before the phosgenation. In the case of the transesterification process the branching agents are employed together with the dihydroxyaryl compounds.

Particularly preferred polycarbonates are the homopolycarbonate based on bisphenol A, the homopolycarbonate based on 1,1-bis(4-hydroxyphenyl)-3,3,5-trimethylcyclohexane, 4,4′-dihydroxybiphenyl, and the copolycarbonates based on the two monomers bisphenol A and 1,1-bis(4-hydroxyphenyl)-3,3,5-trimethylcyclohexane and also homo- or copolycarbonates derived from the diphenols of formulae (I), (II) and (III)

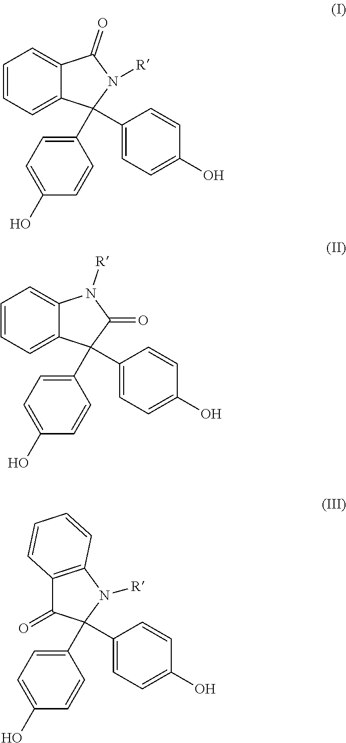

in which R′ in each case stands for C₁- to C₄-alkyl, aralkyl or aryl, preferably for methyl or phenyl, very particularly preferably for methyl.

Preferred are also polycarbonates for the production of which dihydroxyaryl compounds of the following formula (1a) have been used:

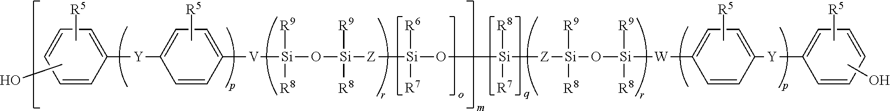

(1a),
wherein
R⁵ stands for hydrogen or C₁- to C₄-alkyl, C₁- to C₄-alkoxy, preferably for hydrogen or methyl or methoxy particularly preferably for hydrogen,
R⁶, R⁷, R⁸ and R⁹ mutually independently stand for C₆- to C₁₂-aryl or C₁- to C₄-alkyl, preferably phenyl or methyl, in particular for methyl,
Y stands for a single bond, SO₂—, —S—, —CO—, —O—, C₁- to C₆-alkylene, C₂- to C₅-alkylidene, C₆- to C₁₂-arylene, which can optionally be condensed with further aromatic rings containing hetero atoms, or for a C₅- to C₆-cycloalkylidene residue, which can be singly or multiply substituted with C₁- to C₄-alkyl, preferably for a single bond, —O—, isopropylidene or for a C₅- to C₆-cycloalkylidene residue, which can be singly or multiply substituted with C₁- to C₄-alkyl,
V stands for oxygen, C₂- to C₆-alkylene or C₃- to C₆-alkylidene, preferably for oxygen or C₃-alkylene,
p, q and r mutually independently each stand 0 or 1,
if q=0, W is a single bond, if q=1 and r=0 is, W stands for —O—, C₂- to C₆-alkylene or C₃- to C₆-alkylidene, preferably for —O— or C₃-alkylene,
if q=1 and r=1, W and V mutually independently stand for C₂- to C₆-alkylene or C₃- to C₆-alkylidene, preferably for C₃ alkylene,
Z stands for C₁- to C₆-alkylene, preferably C₂-alkylene,
o stands for an average number of repeating units from 10 to 500, preferably 10 to 100 and
m stands for an average number of repeating units from 1 to 10, preferably 1 to 6, particularly preferably 1.5 to 5.

It is also possible to use dihydroxyaryl compounds, in which two or more siloxane blocks of general formula (1a) are linked via terephthalic acid and/or isophthalic acid under formation of ester groups.

Especially preferable are (poly)siloxanes of the formulae (2) and (3)

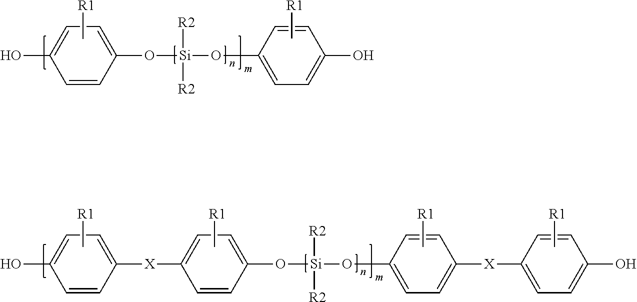

(3),
wherein R¹ stands for hydrogen, C₁- to C₄-alkyl, preferably for hydrogen or methyl and especially preferably for hydrogen,
R² mutually independently stand for aryl or alkyl, preferably for methyl,
X stands for a single bond, —SO₂—, —CO—, —O—, —S—, C₁- to C₆-alkylene, C₂- to C₅-alkylidene or for C₆- to C₁₂-arylene, which can optionally be condensed with further aromatic rings containing hetero atoms,
X stands for a single bond, —SO₂—, —CO—, —O—, —S—, C₁- to C₆-alkylene, C₂- to C₅-alkylidene, C₅- to C₁₂-cycloalkylidene or for C₆- to C₁₂-arylene, which can optionally be condensed with further aromatic rings containing hetero atoms,
X preferably stands for a single bond, isopropylidene, C₅- to C₁₂-cycloalkylidene or oxygen, and especially preferably stands for isopropylidene,
n means an average number from 10 to 400, preferably 10 and 100, especially preferably 15 to 50 and
m stands for an average number from 1 to 10, preferably 1 to 6 and especially preferably from 1.5 to 5.

Also preferably the siloxane block can be derived from one of the following structures:

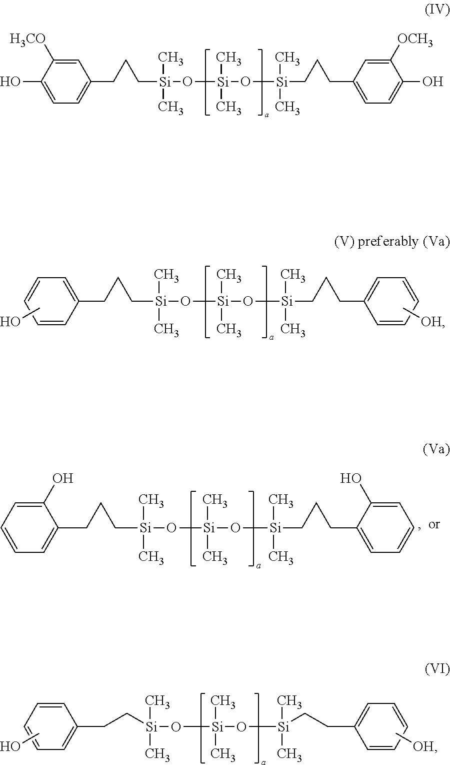

wherein a in formulae (IV), (V) und (VI) means an average number from 10 to 400, preferably from 10 to 100 and especially preferably from 15 to 50.

It is equally preferable, that at least two of the same or different siloxane blocks of the general formulae (IV), (V) or (VI) are linked via terephthalic acid and/isophthalic acid under formation of ester groups.

It is also preferable, if p=0 in formula (1a), V stands for C₃-alkylene,
if r=1, Z stands for C₂-alkylene, R⁸ and R⁹ stand for methyl,
if q=1, W stands for C₃-alkylene,
if m=1, R⁵ stands for hydrogen or C₁- to C₄-alkyl, preferably for hydrogen or methyl, R⁶ and R⁷ mutually independently stand for C₁- to C₄-alkyl, preferably methyl, and o stands for 10 to 500

Copolycarbonates with monomer units of the general formula (1a), in particular with bisphenol A, and in particular the production of those copolycarbonates are described in WO 2015/052106 A2.

Depending on the required needs with regard to the properties of the thermoplastic composition, the composition contains further components in addition to the polymer, which is preferably a polycarbonate or polycarbonate blend, itself.

Fillers may be added to achieve properties such as dimensional stability and/or thermal conductivity, while conventional additives are added to further modify the properties of the thermoplastic composition.

At least for the heatsink of the LED headlight unit, a thermally conductive thermoplastic material is used. Such a material comprises a thermally conductive additive which may be chosen according the respective needs. Many thermally conductive fillers are available on the market which allow to provide compositions with the required thermal conductivities.

Such a thermally conductive additive may be graphene, graphite, in particular expanded graphite, aluminum or other metal particles, carbon fiber, or other conductor, or thermally conductive polymers. In a preferred embodiment, expanded graphite is contained in the thermally conductive thermoplastic material as thermally conductive additive. Expanded graphite and methods of its production are known to those skilled in the art.

The thermoplastic composition may optionally comprise one or more further commercially available polymer additives such as flame retardants, flame retardant synergists, anti-dripping agents (for example compounds of the substance classes of the fluorinated polyolefins), lubricants, flow enhancers, mold release agents, transesterification stabilizers, nucleating agents, heat stabilizers, antioxidants, UV absorbers, IR absorbers, antistatic agents, colorants, pigments and mixtures thereof.

The material used for the injections moldings steps is a thermoplastic material. It can be the same material or a different material for the heatsink and the optics component.

The thermoplastic material is based on a thermoplastic polymer, such as polycarbonate incl, co-polycarbonate, polycarbonate blends incl. co-polycarbonate blends, in particular with PET, PBT or ABS, polyamide, polymethyl methacrylate, polystyrene, styrene acrylonitriles, cycloolefin copolymers, polyesters or mixtures of these. Preferably, the thermoplastic material is a composition based on polycarbonate or a polycarbonate blend.

“Based on” is understood so as to mean that the thermoplastic composition comprises at least 50 wt.-%, preferably at least 60 wt.-%, particularly preferably at least 70 wt.-% of the respective polymer.

A preferred LED headlight unit according to the invention is a headlight unit comprising: a heat sink that is formed from a first thermoplastic material based on polycarbonate and integrates an LED module; and
an optics component, wherein the optics component is a reflector, that is formed from a second thermoplastic material based on polycarbonate on a top surface of the heat sink. The first thermoplastic material and the second thermoplastic material may be the same material based on polycarbonate or a different material based on polycarbonate.

In case of the optics element being a reflector, a part of it or all of its surface is preferably metallized for achieving a good reflection.

The application of metals to a polymer can be effected via various methods, such as e.g. by vapor deposition or sputtering. The processes are described in more detail e.g. in “Vakuumbeschichtung vol. 1 to 5”, H. Frey, VDI-Verlag Düsseldorf 1995 or “Oberflächen- und Dunnschicht-Technologie” part 1, R. A. Haefer, Springer Verlag 1987.

In order to achieve a better adhesion of the metal and in order to clean the substrate surface, the substrates are usually subjected to a plasma pretreatment. Under certain circumstances, a plasma pretreatment can modify the surface properties of polymers. These methods are described e.g. by Friedrich et al. in Metallized plastics 5 & 6: Fundamental and applied aspects and H. Grünwald et al. in Surface and Coatings Technology 111 (1999) 287-296.

Alternatively, the reflector portion can be molded to the housing, or to the housing heat sink, using the two shot molding process described above, where the metalized reflector is molded first, and then the housing is molded to it. In another embodiment, the reflector portion may be molded to the housing, or to the housing heat sink, before it is metallized. In yet another embodiment, the housing or the housing heat sink comprises the reflector portion, and that portion is metalized after molding. In addition, another coating may be applied to the reflector portion before it is metalized.

Further layers, such as corrosion-reducing protective sizes, can be applied in a PECVD (plasma enhanced chemical vapor deposition) or plasma polymerization process. In these, low-boiling precursors chiefly based on siloxane are vaporized in a plasma and thereby activated, so that they can form a film. Typical substances here are hexamethyldisiloxane (HMDSO), tetramethyldisiloxane, decamethylcyclopentasiloxane, octamethylcyclotetrasiloxane and trimethoxymethylsilane.

Possible metals are, preferably, Ag, Al, Ti, Cr, Cu, VA steel, Au, Pt, particularly preferably Ag, Al, Ti or Cr. Very particularly preferred thermoplastic compositions used for the optics component, preferably a reflector, and/or the heatsink component are those thermoplastic compositions described in WO 2022/112405 A1 which is hereby incorporated by reference. The compositions described in WO 2022/112405 A1 exhibit a good dimensional stability as well as good surface properties of the molded parts, which can be seen in the examples section of WO 2022/112405 A1, which is of particularly importance for a reflector. Such thermoplastic compositions comprise:
a) 44 to 63 wt.-% of aromatic polycarbonate,
b) 3 to 8 wt.-% of expanded graphite,
c) 34 to 38 wt.-% fused silica,
d) 0 to 10 wt.-% of one or more additives other than components b or c,
wherein the total amount of expanded graphite and fused silica is at least 40 wt.-%.

Particularly preferred compositions used for the reflector are those consisting of
a) 54 to 60 wt.-% aromatic polycarbonate,
b) 5 to 7.5 wt.-% expanded graphite, in particular with a d(0.5) of the expanded graphite of 700 μm to 1200 μm, determined by sieve analysis according to DIN 51938:2015-09,
c) 35 to 37.5 wt.-% of fused Silica, in particular with a D(0.5) of the fused silica of 3 μm to 5 μm, determined according to ISO 13320:2009-10,
d) 0 to 5 wt.-% of one or more additives other than components b or c, wherein the total amount of expanded graphite and fused silica is at least 40 wt.-%, particularly preferred at least 42 wt.-%, wherein particularly preferable at least one demoulding agent, a thermostabilizer and/or antioxidant and carbon black are contained as additives.

If similar materials are used for the heat sink and the optics element, e.g. polycarbonate based materials in both cases, the LED headlight unit according to the invention has the advantage that it can be easily and efficiently recycled.

Alternatively, for the optics component, preferably a composition as described in WO2013079555A1 is used.

Particularly preferred material disclosed in this document is a thermoplastic composition consisting of
A) 30.0 to 90.0 parts by wt. of at least one aromatic polycarbonate,
B) 0.0 part by wt. to 50.0 parts by wt. of rubber-modified graft polymer and/or vinyl copolymer,
C) 0.00 to 50.00 parts by wt. of polyester,
D) 5.0 to 50.0 parts by wt. of at least one inorganic filler having a spherical grain shape, where the filler is quartz,
E) 0.00 to 5.00 parts by wt. of further conventional additives, selected from the group of the flame retardants, the antidripping agents, the lubricants and mould-release agents, the nucleating agents, the dyes, pigments, UV stabilizers, heat stabilizers, hydrolysis stabilizers and antioxidants, where the sum of the parts by weight of components A) to E) gives a total of 100 parts by weight.

For the heatsink an alternative material is described EP2721111B1, in particular a composition comprising: 90 wt.-% to 30 wt.-% of at least one amorphous thermoplastic, wherein the amorphous thermoplastic is selected from the group consisting of polycarbonate and polymethylmethacrylate (PMMA); and 10 wt.-% to 70 wt.-% of expanded graphite, wherein 90% of the particles of the expanded graphite have a particle size of at least 200 microns, wherein the particle size is determined by sieve analysis.

The heat sink 410 of the molded LED systems 400A may be formed from a thermoplastic material with high thermal conductivity and high thermal emissivity. The selection of the thermoplastic is critically important because the material needs to be compatible with the thermoplastic of the optics component 444. Examples of such materials include Makrolon® TC629.

Additionally, if similar materials are used for the heat sink 410 and the optics component 444 (e.g., polycarbonate based materials in both cases), the LED headlight unit 450 has the advantage that it can be easily and efficiently recycled.

In some instances, the heat sink 410 may be in thermal contact with the optics component 444 so that the optics component 444 acts an additional heat sink. In some instances, the thermoplastic that forms the optics component 444 may be the same as the thermoplastic that forms the heatsink 410. In these instances, the optics component 444 can serve both the heat dissipation functions as well as the optical functions.

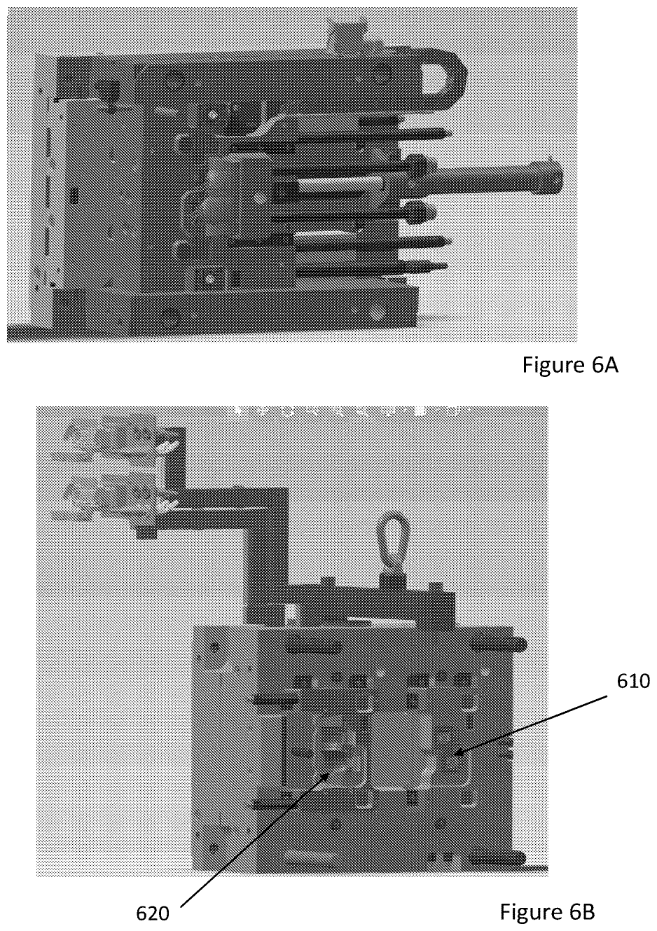

The over-molded LED systems 400A and 400B may further include an LED module 420 that may contain LEDs 414. In some instances, the LED Module 420 includes a plurality of LEDs 414 that may or may not have an interposer. In addition, in some instances, the LED Module 420 may include a heat conductive spreading element (such as from Al or Cu) that may transfer heat generated by the individual LEDs 414 to the heat sink 410. In addition, the LED Module 420 may also include a circuit board to connect the LEDs to an appropriate power source, including required electrical components and a connector 412. In some instances, the LED module 420 includes first reference features 430 that are used to align the LED module to a cavity of a mold of a molding apparatus. In some instances, the reference feature 430 may be a hole, indention, edge or tab. And in some instances, the LED module 420 includes a fixation features 435 that geometrically align the LED module 420 to the heatsink and support the mechanical connection and integration of the LED module 420 to the heatsink 410. For example, in some instances the fixation feature 435 may be two holes. In these instances, the two holes provide improved fixation and/or bonding between LED-module 420 and the heatsink 410. An example of a molding apparatus is shown in FIGS. 6A and 6B and described in more detail below.

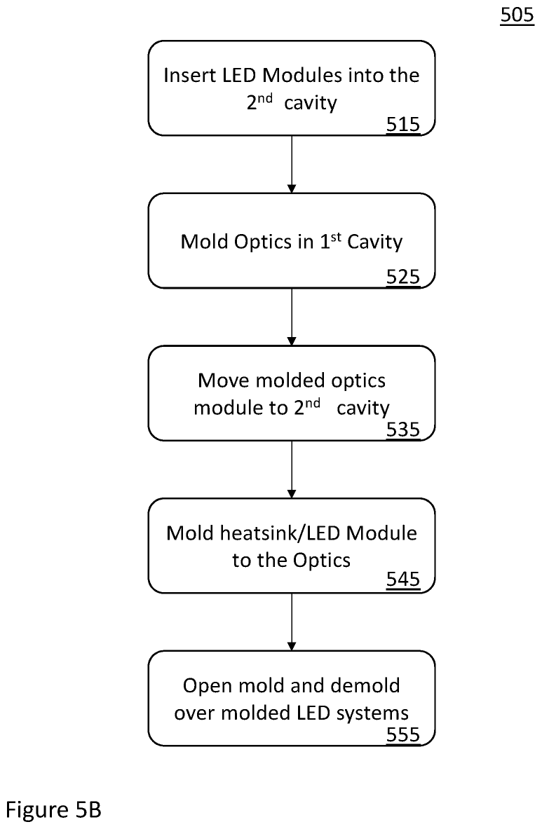

FIG. 5A is a flow diagram of an example method 500 of manufacturing the LED headlight unit 450 that may include the over-molded LED systems 400A and 400B. The LED modules 420A/B may inserted in a first cavity of a mold (510). The mold may then be closed. In some instances, the molding tool may have the corresponding reference features integrated that match reference features 430 of the LED systems 400A and 400B. For example, in some instances, pins can be inserted into holes in the LED module when the reference feature 430 is a hole. In another instance, a defined reference edge at the LED module 420 can have corresponding alignment edges in the tool so that the LED module 420 may be pressed against the reference before the tool is closed (e.g., by gravity).

The thermoplastic material with high thermal conductivity and high thermal emissivity may be injected molded onto the LED module 420 to form the heat sink 410 (520). The injection molding firmly attaches the LED module 420 into the heatsink 410 without the need for additional fasteners or glues.

In some instances, the thermoplastic material with high thermal conductivity and high thermal emissivity have a melt temperature between 280° C.-350° C. In many situations, the mold temperature is determined based on the melt temperature of the thermoplastic material with high thermal conductivity and high thermal emissivity. For example, a melt temperature range of 280° C.-350° C. may correspond to a mold temperature range of 80° C.-120° C.

In some instances, the thermoplastic material with high thermal conductivity and high thermal emissivity may be molded at a mold temperature of 90° C. and a pressure of 950 bar. However, the pressure utilized is depended on the geometry of heat sink 410 and the mold design. For example, 950 bar might be a good result, but it could also be 100 bar (special low pressure molding techniques) or 2000 bar (often the machine limit). However, when over molding the heatsink 410 onto the LED module 420 is critical that the pressure be low enough so as not to deform the LED module 420. Accordingly, while the heat sink 410 may be molded using a pressure of between 100-2000 bar, it is highly desirable to use a pressure below 1000 bar to ensure that the LED module 420 does not deform during injection molding.

The molded LED heat sink formed in 520 may then be moved to a second cavity (530), and the mold may again be closed. In some instances, the moving is performed using a sliding table such as depicted in FIG. 6A. In other instances, the moving is accomplished by a sliding table, rotary plate, and/or a rotating index plate.

The optics component 444 may then be injection molded onto a top surface of the molded heat sink by injecting a second thermoplastic into the second cavity (540). In some instances, the second thermoplastic may be injection molded at a mold temperature of 165° C. and then cooled to a mold temperature of 90° C. prior to opening the mold. In some instances, the second thermoplastic may be injection molded at 780 bars. In some instances, the molded LED module and heat sink formed in 520 may be maintained at 90° C. while the optics component is injection molded on the top surface.

In some instances, the injection molding of the optics components 444 is performed using a vario-thermal process. The vario-thermal process is used to improve the surface quality of the optics component. For example, in a vario-thermal process prior to the injection, the mold is heated up to about 140-170° C. After the injection, the mold is cooled down to about 90° C. prior to the part being removed. The decision to utilize the vario-thermal process may be made based on the second thermal plastic used or the surface quality of the optics component desired.

In other instances, the injection molding of the optics component 444 may be performed using a constant thermal process with a mold temperature of between 60° C. and 120° C.

However, like in the case of molding the heat sink in step 520, the molding of the optics component 444 in step 540 is also dependent on the properties of the second thermoplastic used. For example, a second thermal plastic with a melt temperature range of 280° C.-350° C. may require a mold temperature range of 60° C.-120° C. in the case of a constant thermal process. And the same material would require a mold temperature range of 120° C.-180° C. when used in the vario-thermal process. However, in all cases, the mold temperature must be above the glass temperature of the second thermoplastic material.

Like in the molding of the heat sink in step 520, the pressure utilized in the molding of the optics component 444 in step 540 is highly dependent on the geometry of the optics component and of the mold. For example, 780 bar might be a good result, but it could also be again 100 bar (special low pressure molding techniques) or 2000 bar (often the machine limit). Yet is it critical in the selection of the pressure that the pressure is low enough such that high warpage of the optics component 444 is avoided. As a result, the molding in step 540 may be performed between 100-2000 bar for the molding process. However, it is preferred that the pressure is below 1000 bar to ensure low warpage of the optics component 444.

In some instances, the second thermoplastic may be the same material as the high thermal conductivity and high thermal emissivity thermoplastic used in 520. Or a material which has both sufficient thermal emissivity and dimensional stability to be used for the heatsink and optics. thermoplastic should be made based on the properties of the materials discussed above. Additionally, if similar materials are used for the heat sink 410 and the optics component 444 (e.g. polycarbonate based materials in both cases), the LED headlight unit 450 has the advantage that it can be easily and efficiently recycled.

The mold may then be opened, and the LED headlight unit 450 may be demolded (550). In case a case where optics component 444 is a reflector, a part of it or all of its surface is maybe preferably metallized for achieving a good reflection after the LED headlight unit 450 is demolded.

The application of metals to a polymer can be affected via various methods, such as e.g. by vapor deposition or sputtering. The processes are described in more detail e.g. in “Vakuumbeschichtung vol. 1 to 5”, H. Frey, VDI-Verlag Düsseldorf 1995 or “Oberflächen- und Dunnschicht-Technologie” part 1, R. A. Haefer, Springer Verlag 1987.

In order to achieve a better adhesion of the metal and in order to clean the substrate surface, the substrates are usually subjected to a plasma pretreatment. Under certain circumstances, a plasma pretreatment can modify the surface properties of polymers. These methods are described e.g. by Friedrich et al. in Metallized plastics 5 & 6: Fundamental and applied aspects and H. Grünwald et al. in Surface and Coatings Technology 111 (1999) 287-296.

FIG. 5B is a flow diagram of an example of an alternative method 505 of manufacturing the LED headlight unit 450 that may include the over-molded LED systems 400A and 400B. The LED modules 420A/B may inserted in a second cavity of a mold (515). The mold may then be closed. In some instances, the molding tool may have the corresponding reference features integrated that match reference features 430 of the LED systems 400A and 400B. For example, in some instances, pins can be inserted into holes in the LED module when the reference feature 430 is a hole. In another instance, a defined reference edge at the LED module 420 can have corresponding alignment edges in the tool so that the LED module 420 may be pressed against the reference before the tool is closed (e.g., by gravity).

The optics component may then be injection molded into the first cavity (525). In some instances, the thermoplastic used for the optics component may be injection molded using the vario-thermal process, as discussed above. In other instances, the injection molding may be performed using a constant thermal process, as discussed above.

The molded optics component formed in 525 may be moved to a second cavity (535), and the mold may again be closed. In some instances, the moving is performed using a sliding table such as depicted in FIG. 6A. In other instances, the moving is accomplished by a sliding table, rotary plate, and/or a rotating index plate.

The thermoplastic material with high thermal conductivity and high thermal emissivity may be injected molded onto a bottom surface of the optics component molded in step 525 to form the heat sink 510 (545). The molding of the heat sink to the optics component in step 545 also integrates the LED module 420 into the heat sink 510.

In some instances, the thermoplastic material with high thermal conductivity and high thermal emissivity may be molded utilizing the parameters discussed in step 520.

The mold may then be opened, and the LED headlight unit 450 may be demolded (555). As discussed with regard to step 550, in a case where optics component 444 is a reflector, a part of it or all of its surface is maybe preferably metallized for achieving a good reflection after the LED headlight unit 450 is demolded.

In some instances, the injection molding described with respect to FIG. 5A and FIG. 5B may be performed using 2 k molding. 2K molding is beneficial because 2 k molding improves accuracy, efficiency and bonding behavior between the two thermoplastics due to the fact the both components are molded short-termly directly after the other. In other instances, other plastic over molding techniques may be used. Examples of other over-molding techniques that may be utilized include two separate injection molding steps. For example, the headlight unit may be formed by in two district steps. In the 1st injection molding of the heatsink and afterwards to place the heatsink in a 2nd mold/machine to over mold the optics on to the heat sink.

FIGS. 6A and 6B illustrate an example molding apparatus that may be utilized to implement process 500. Specifically, FIG. 6B shows the first cavity 610, in which the heat sink is formed, the second cavity 620 that is utilized to form the optics component 444, respectively. An example of a sliding table that may be utilized to move the part between the first cavity 610 and the second cavity 620 is shown in FIG. 6A.

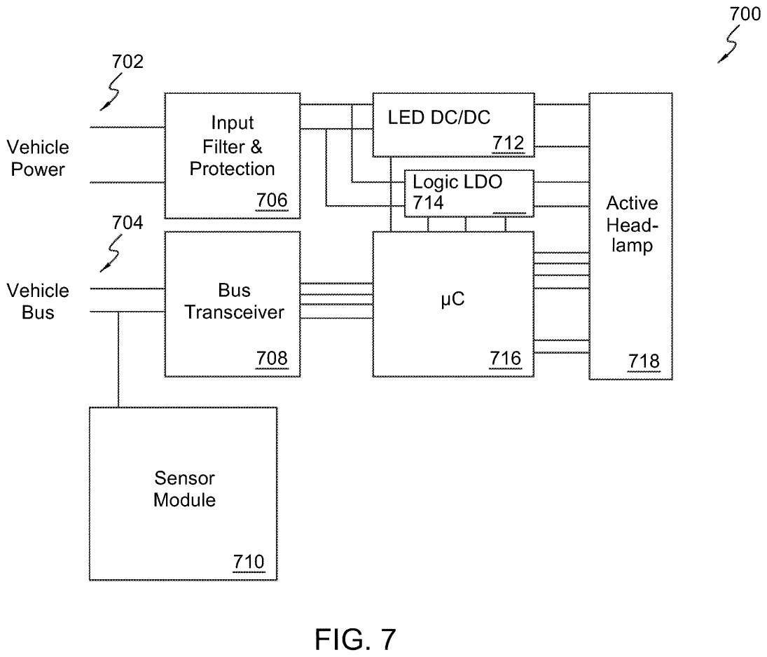

FIG. 7 is a diagram of an example vehicle headlamp system 700 that may incorporate one or more of the embodiments and examples described herein. The example vehicle headlamp system 700 illustrated in FIG. 7 includes power lines 702, a data bus 1004, an input filter and protection module 706, a bus transceiver 708, a sensor module 710, an LED direct current to direct current (DC/DC) module 712, a logic low-dropout (LDO) module 714, a micro-controller 716 and an active headlamp 718.

The power lines 702 may have inputs that receive power from a vehicle, and the data bus 704 may have inputs/outputs over which data may be exchanged between the vehicle and the vehicle headlamp system 700. For example, the vehicle headlamp system 700 may receive instructions from other locations in the vehicle, such as instructions to turn on turn signaling or turn on headlamps, and may send feedback to other locations in the vehicle if desired. The sensor module 710 may be communicatively coupled to the data bus 704 and may provide additional data to the vehicle headlamp system 700 or other locations in the vehicle related to, for example, environmental conditions (e.g., time of day, rain, fog, or ambient light levels), vehicle state (e.g., parked, in-motion, speed of motion, or direction of motion), and presence/position of other objects (e.g., vehicles or pedestrians). A headlamp controller that is separate from any vehicle controller communicatively coupled to the vehicle data bus may also be included in the vehicle headlamp system 700. In FIG. 7, the headlamp controller may be a microcontroller, such as a microcontroller (pc) 716. The microcontroller 1016 may be communicatively coupled to the data bus 704.

The input filter and protection module 706 may be electrically coupled to the power lines 702 and may, for example, support various filters to reduce conducted emissions and provide power immunity. Additionally, the input filter and protection module 706 may provide electrostatic discharge (ESD) protection, load-dump protection, alternator field decay protection, and/or reverse polarity protection.

The LED DC/DC module 712 may be coupled between the input filter and protection module 706 and the active headlamp 718 to receive filtered power and provide a drive current to power LEDs in the LED array in the active headlamp 718. The LED DC/DC module 712 may have an input voltage between 10 and 18 volts with a nominal voltage of approximately 13.2 volts and an output voltage that may be slightly higher (e.g., 0.3 volts) than a maximum voltage for the LED array (e.g., as determined by a factor or local calibration and operating condition adjustments due to load, temperature or other factors).

The logic LDO module 714 may be coupled to the input filter and protection module 706 to receive the filtered power. The logic LDO module 714 may also be coupled to the microcontroller 716 and the active headlamp 718 to provide power to the microcontroller 1016 and/or electronics in the active headlamp 718, such as CMOS logic.

The bus transceiver 708 may have, for example, a universal asynchronous receiver transmitter (UART) or serial peripheral interface (SPI) interface and may be coupled to the microcontroller 716. The micro-controller 716 may translate vehicle input based on, or including, data from the sensor module 710. The translated vehicle input may include a video signal that is transferrable to an image buffer in the active headlamp 718. In addition, the microcontroller 716 may load default image frames and test for open/short pixels during startup. In embodiments, an SPI interface may load an image buffer in CMOS. Image frames may be full frames, differential, or partial frames. Other features of microcontroller 716 may include control interface monitoring of CMOS status, including die temperature, as well as logic LDO output. In embodiments, LED DC/DC output may be dynamically controlled to minimize headroom. In addition to providing image frame data, other headlamp functions, such as complimentary use in conjunction with side marker or turn signal lights and/or activation of daytime running lights, may also be controlled.

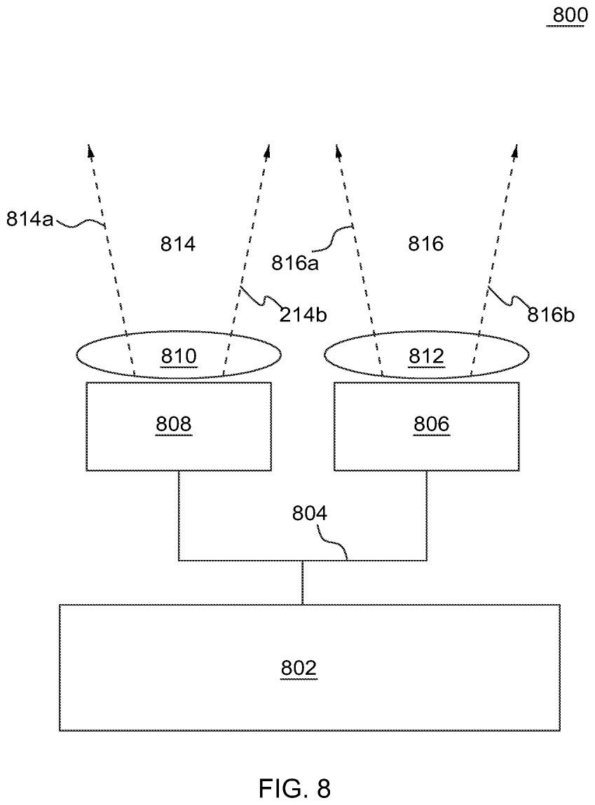

FIG. 8 is a diagram of another example vehicle headlamp system 800. The example vehicle headlamp system 800 illustrated in FIG. 8 includes an application platform 802, two LED lighting systems 806 and 808, and secondary optics 810 and 812.

The LED lighting system 808 may emit light beams 814 (shown between arrows 814a and 814b in FIG. 8). The LED lighting system 806 may emit light beams 816 (shown between arrows 816a and 816b in FIG. 8). In the embodiment shown in FIG. 8, a secondary optic 810 is adjacent the LED lighting system 808, and the light emitted from the LED lighting system 808 passes through the secondary optic 810. Similarly, a secondary optic 812 is adjacent the LED lighting system 806, and the light emitted from the LED lighting system 806 passes through the secondary optic 812. In alternative embodiments, no secondary optics 810/812 are provided in the vehicle headlamp system.

Where included, the secondary optics 810/812 may be or include one or more light guides. The one or more light guides may be edge-lit or may have an interior opening that defines an interior edge of the light guide. LED lighting systems 808 and 806 may be inserted in the interior openings of the one or more light guides such that they inject light into the interior edge (interior opening light guide) or exterior edge (edge lit light guide) of the one or more light guides. In embodiments, the one or more light guides may shape the light emitted by the LED lighting systems 808 and 806 in a desired manner, such as, for example, with a gradient, a chamfered distribution, a narrow distribution, a wide distribution, or an angular distribution.

The application platform 802 may provide power and/or data to the LED lighting systems 806 and/or 808 via lines 804, which may include one or more or a portion of the power lines 802 and the data bus 804 of FIG. 8. One or more sensors (which may be the sensors in the vehicle headlamp system 800 or other additional sensors) may be internal or external to the housing of the application platform 802. Alternatively, or in addition, as shown in the example vehicle headlamp system 800 of FIG. 8, each LED lighting system 808 and 806 may include its own sensor module, connectivity, and control module, power module, and/or LED array.

In embodiments, the vehicle headlamp system 800 may represent an automobile with steerable light beams where LEDs may be selectively activated to provide steerable light. For example, an array of LEDs or emitters may be used to define or project a shape or pattern or illuminate only selected sections of a roadway. In an example embodiment, infrared cameras or detector pixels within LED lighting systems 806 and 808 may be sensors (e.g., similar to sensors in the sensor module 710 of FIG. 7) that identify portions of a scene (e.g., roadway or pedestrian crossing) that require illumination.

In some instances, LED headlight unit 450 may be manufactured, at least in part, using a computer-aided design (CAD) software package. Non-limiting embodiments of the CAD software are Solid Works, ProEngineer, AutoCAD, and CATIA. The CAD software may generate a 3-dimensional model of the LED headlight unit 450. In addition, the CAD software may generate instructions that, when executed by a Computer Numerical Control (CNC) machine, cause the CNC machine to produce the models for the cavities required to model the LED headlight unit 450 according to the 3-dimensional model generated by the CAD software package. Examples of CNC machines that may be utilized to produce the LED headlight unit 450 include drills, lathes, mills, grinders, routers, and 3D printers. In some instances, the instructions, when executed by the CNC machine, cause the CNC to generate a mold that may be subsequently utilized to form the LED headlight unit 450. In some instances, the CAD software may also generate instructions for controlling a molding machine to form the LED headlight unit 450 utilizing process 500. Examples of a molding machine include a 2K molding machine.

Having described the embodiments in detail, those skilled in the art will appreciate that, given the present description, modifications may be made to the embodiments described herein without departing from the spirit of the disclosure. Therefore, it is not intended that the scope of the disclosure be limited to the specific embodiments illustrated and described.

1. A method of manufacturing a light emitting diode (LED) headlight unit, the method comprising:
inserting an LED module into a first cavity;
performing a first injection molding that injects a first thermoplastic into the first cavity to form a heat sink that integrates the LED module;
moving the heat sink into a second cavity;
performing a second injection molding that injects a second thermoplastic in the second cavity to integrally form an optics component on a top surface of the heat sink that integrates the LED module; and
demolding the optics component and the heat sink that integrates the LED module to form the LED headlight unit.

2. The method of manufacturing according to claim 1, wherein the LED module includes a first reference feature, and
the inserting utilizes the reference feature to align the LED module with the first cavity.

3. The method of manufacturing according to claim 1, wherein the optics component is a lens or a reflector.

4. The method of manufacturing according to claim 1, wherein the LED module includes a fixation feature that aligns the LED module relative to the heat sink.

5. The method of manufacturing according to claim 1, wherein the first thermal plastic is a thermally conductive polycarbonate or a polycarbonate blend.

6. The method of manufacturing according to claim 1, wherein the second thermal plastic is a same material as the first thermal plastic.

7. A light emitting diode (LED) headlight unit comprising:
a heat sink that is formed from a first thermoplastic and integrates an LED module; and
an optics component that is integrally formed from a second thermoplastic on a top surface of the heat sink.

8. The LED headlight unit of claim 7, wherein the LED module includes a first reference feature that aligns the LED module to a first cavity that forms the heat sink.

9. The LED headlight unit of claim 7, wherein the optics component is a lens or a reflector.

10. The LED headlight unit of claim 7, wherein the LED module includes a fixation feature that aligns the LED module relative to the heat sink.

11. The LED headlight unit of claim 7, wherein the first thermal plastic is a thermally conductive polycarbonate or a polycarbonate blend.

12. The method of claim 1, wherein the second thermal plastic is a same material as the first thermal plastic.

13. A non-transitory computer readable storage medium storing instructions for forming a light emitting diode (LED) headlight unit, the instructions when executed by an injection molding machine, cause the injection molding machine to execute a method comprising:
performing a first injection molding that injects a first thermoplastic into a first cavity to form a heat sink that integrates an LED module device;
moving the heat sink into a second cavity;
performing a second injection molding that injects a second thermoplastic in the second cavity to form an optics component on a top surface of the heat sink that integrates the LED module; and
demolding the optics component and the heat sink that integrates the LED module to form the LED headlight unit.

14. The non-transitory computer readable storage medium of claim 13, wherein the LED module includes a reference feature that aligns the LED module to the first cavity.

15. The non-transitory computer readable storage medium of claim 13, wherein the optics component is a lens or reflector.

16. The non-transitory computer readable storage medium of claim 13, wherein the LED module includes a fixation feature that aligns the LED module relative to the heat sink.

17. The non-transitory computer readable storage medium of claim 13, wherein the first thermal plastic is a thermally conductive polycarbonate or a polycarbonate blend.

18. The non-transitory computer readable storage medium of claim 13, wherein the second thermal plastic is a same material as the first thermal plastic.

19. A method of manufacturing a light emitting diode (LED) headlight unit, the method comprising:
inserting an LED module into a second cavity;
performing a first injection molding that injects a first thermoplastic in the first cavity to form an optics component;
moving the molded optics component into the second cavity;
performing a second injection molding that injects a first second thermoplastic into the second cavity to form a heat sink that integrates the LED module on a bottom surface of the optics component; and demolding the optics component and the heat sink that integrates the LED module to form the LED headlight unit.

20. The LED headlight unit made by the method of claim 19.
